(19) United States
(12) Patent Application Publication
(10) Pub. No.: US 2013/0265693 A1
(43) Pub. Date: Oct. 10, 2013

(54) CIRCUIT BREAKER

(71) Applicant: ABB TECHNOLOGY AG, Zurich (CH)

(72) Inventors: Emmanouil PANOUSIS, Baden (CH); Marcelo BUFFONI, Zurich (CH); Markus BUJOTZEK, Zurich (CH); Bernardo GALLETTI, Nussbaumen (CH)

(73) Assignee: ABB Technology AG, Zurich (CH)

(21) Appl. No.: 13/857,651

(22) Filed: Apr. 5, 2013

(30) Foreign Application Priority Data
Apr. 5, 2012 (EP) 12163269.9

(51) Int. Cl. H01H 33/08

(52) U.S. Cl. CPC H01H 33/08
USPC 361/634; 218/149

(57) ABSTRACT

A medium or high-voltage circuit breaker is provided. An arc-extinguishing fluid is stored in a pressure chamber, which is made up by an arcing chamber of the circuit breaker where an electrical arc is extinguished. No tubings or other conduction devices for pressurized fluids are necessary during current interruption. This speeds up contact separation and arc extinguishing. In a first, closed position of the circuit breaker, the pressure chamber is delimited by a sealing wall which is fixed to a movable first arcing contact. The sealing wall acts as a valve and as a piston at the same time, because it opens the outflow of pressurized arc extinguishing fluid and it concurrently actuates arcing contact separation. The arcing chamber enables the stored pressurized arc extinguishing fluid to perform fast contact separation within a few milliseconds and extinguishing a gaseous arc on the same timescale.

### RELATED APPLICATION

This application claims priority under 35 U.S.C. §119 to European Patent Application No. 12163269.9 filed in Europe on Apr. 5, 2012, the entire content of which is hereby incorporated by reference in its entirety.

### FIELD

The present disclosure relates to a circuit breaker for a medium or high-voltage electrical circuit. Furthermore, the present disclosure relates to a method for circuit interruption by means of such a circuit breaker and the use of such a circuit breaker in a medium or high-voltage power transmission or distribution network. The present disclosure also relates to a power transmission or distribution network including such a circuit breaker.

### BACKGROUND INFORMATION

Known circuit breakers can include compressed fluids (e.g., gases and/or liquids) as energy reservoirs and piston mechanisms as actuators. In these devices, the stored drive energy is in general used for both mechanical actuation (e.g., separation) of electrical contacts and for pressure buildup in an arc extinguishing fluid. During contact actuation, nominal contacts (e.g., medium or high-voltage contacts that are used during normal, i.e., non-tripping operation) and/or arcing contacts (e.g., medium or high-voltage contacts that are used during tripping of the circuit) in an arcing chamber are mechanically separated to prevent further current flow in the circuit. However, due to voltages above 1 kV, a plasma arc is formed between the already separated arcing contacts. During arc extinguishing, this plasma arc between the arcing contacts is purged by a flow of arc extinguishing fluid during a natural induced zero crossing of the current (e.g., in an AC network) or during an artificially induced zero crossing of the current (e.g., in a DC network) through the arcing contacts. For this, high blowing pressures are used in the arc extinguishing fluid. If the arc extinguishing fluid is not pre-pressurized, for example, by a compressor, the necessary buildup of pressure in the arc extinguishing fluid normally takes place by means of a compression of a gaseous volume of the arc extinguishing fluid (so-called “puffer” technology) in a way similar to handheld pumps for bicycles. In other implementations, the circuit breaker is designed such that additional pressure can be generated in the arc extinguishing fluid during the high current arcing phase. This extra pressure is then used for arc interruption at current zero (so-called “self-blast” technology).

U.S. Pat. No. 5,187,339 discloses a high-voltage circuit breaker including a first compartment with pressurized SF₆ as arc extinguishing fluid. The high-voltage arcing contacts are arranged inside this first compartment. A second, normally unpressurized compartment is located at a distance from the first compartment and includes a pneumatic jack which is mechanically connected to the arcing contacts. For circuit tripping, valves separating the first compartment from the pneumatic jack are opened and the pneumatic jack is actuated by the pressurized gas contained in the first compartment. Thus, the arcing contacts can be separated.

U.S. Pat. No. 3,379,849 discloses a high-voltage circuit breaker with pressurized reservoirs containing the arc extinguishing fluid SF₆. Valves are opened for a tripping of the circuit and the arc extinguishing fluid is on the one hand used to actuate a piston mechanism which separates the arcing contacts, and on the other hand it is used for arc extinguishing in the arcing chamber, which is located at a distance to the piston mechanism.

U.S. Pat. No. 7,528,332 discloses an actuating device and a circuit breaker device that rely on an electrical discharge in a gas volume. The electrical discharge is used to rapidly heat the gas and thus increase its pressure. A connected piston mechanism converts the resulting pressure buildup in the gas into a mechanical movement which can be used to mechanically actuate electrical contacts.

The disclosed devices and/or methods have the disadvantage, however, that their setup is rather complicated and/or that they exhibit rather slow mechanical contact actuating and/or arc extinguishing performances.

### SUMMARY

An exemplary embodiment of the present disclosure provides a medium or high-voltage circuit breaker. The exemplary circuit breaker includes at least one first arcing contact and at least one second arcing contact arranged in an arcing chamber. The first arcing contact is movable with respect to the second arcing contact from a first position to a second position. An electrical connection between the arcing contacts is closed in the first position and open in the second position. The exemplary circuit breaker also includes an arc extinguishing fluid configured to extinguish an arc between the first arcing contact and the second arcing contact, and to move the first arcing contact from the first position to the second position. The exemplary circuit breaker includes at least one nozzle arranged in the arcing chamber and configured to direct a flow of the arc extinguishing fluid towards the arc for extinguishing the arc, and a pressure chamber and an expansion chamber. The arc extinguishing fluid is arranged in the pressure chamber at an overpressure to the expansion chamber when the first arcing contact is in the first position. In addition, the exemplary circuit breaker includes at least one movable sealing wall mechanically interconnected to the first arcing contact. The mechanical interconnection is configured to transfer a movement of the sealing wall to the first arcing contact. At least a part of the pressure chamber is formed by the sealing wall when the first arcing contact is in the first position.

An exemplary embodiment of the present disclosure provides a method for interrupting or establishing an electrical connection in a medium or high-voltage power transmission or distribution network, by means of a medium or high-voltage circuit breaker according to an exemplary embodiment of the present disclosure. The exemplary circuit breaker includes at least one first arcing contact and at least one second arcing contact arranged in an arcing chamber. The first arcing contact is movable with respect to the second arcing contact from a first position to a second position. An electrical connection between the arcing contacts is closed in the first position and open in the second position. The exemplary circuit breaker also includes an arc extinguishing fluid configured to extinguish an arc between the first arcing contact and the second arcing contact, and to move the first arcing contact from the first position to the second position. The exemplary circuit breaker includes at least one nozzle arranged in the arcing chamber and configured to direct a flow of the arc extinguishing fluid towards the arc for extinguishing the arc, and a pressure chamber and an expansion chamber. The arc extinguishing fluid is arranged in the pressure chamber at an overpressure to the expansion chamber when the first arcing contact is in the first position. In addition, the exemplary circuit breaker includes at least one movable sealing wall mechanically interconnected to the first arcing contact. The mechanical interconnection is configured to transfer a movement of the sealing wall to the first arcing contact. At least a part of the pressure chamber is formed by the sealing wall when the first arcing contact is in the first position. The exemplary method includes receiving a tripping command by the circuit breaker, accelerating the sealing wall and the first arcing contact and mechanically separating the arcing contacts by the pressurized arc-extinguishing fluid from the pressure chamber, at least one of creating changing an exhaust gap between the nozzle and the sealing wall or between the nozzle and a baffle, and purging the arc by a flow of the arc-extinguishing fluid through the nozzle.

### BRIEF DESCRIPTION OF THE DRAWINGS

Additional refinements, advantages and features of the present disclosure are described in more detail below with reference to exemplary embodiments illustrated in the drawings, in which:

FIG. 1a shows a cross section through an exemplary embodiment of a circuit breaker according to the present disclosure with a first arcing contact in a first position;

FIG. 1b shows a cross section through the exemplary embodiment of the circuit breaker from FIG. 1a in a phase when an arc starts to build up between the first arcing contact and a second contact;

FIG. 1c shows a cross section through the exemplary embodiment of the circuit breaker from FIGS. 1a and 1b in a phase when the arc is about to be purged by a flow of arc extinguishing fluid;

FIG. 2 shows a cross section through an exemplary embodiment of a circuit breaker according to the present disclosure including a curved sealing wall;

FIG. 3 shows a cross section through an exemplary embodiment of a circuit breaker according to the present disclosure including a baffle;

FIG. 4 shows a cross section through an exemplary embodiment of a circuit breaker according to the present disclosure including a pressure chamber which is partly arranged around an arcing chamber and further including a damper and a contact closer;

FIG. 5 shows a cross section through an exemplary embodiment of a circuit breaker according to the present disclosure including a nozzle with a nonlinearly converging and a nonlinearly diverging inner diameter and further including a sealing tube; and

FIG. 6 shows a schematic representation of a DC medium or high-voltage power transmission network including a circuit breaker according to the present disclosure.

### DETAILED DESCRIPTION

Exemplary embodiments of the present disclosure provide an improved circuit breaker that at least partially overcomes the disadvantages noted above with known devices and methods. Exemplary embodiments of the present disclosure also provide a method for interrupting an electrical circuit by means of such a circuit breaker. In addition, exemplary embodiments of the present disclosure provide a use of such a circuit breaker for tripping an electrical connection. Furthermore, exemplary embodiments of the present disclosure provide a high-voltage power transmission or distribution network including such a circuit breaker.

An exemplary embodiment of the present disclosure provides a circuit breaker for tripping an electrical connection in a medium or high-voltage power transmission network. The exemplary circuit breaker includes at least one first arcing contact and at least one second arcing contact. These arcing contacts are structured to be separated from each other for tripping the medium or high-voltage electrical connection. The arcing contacts are arranged in an arcing chamber of the circuit breaker and at least the first arcing contact is movable with respect to the second arcing contact from a first position to a second position. The electrical connection between the arcing contacts is closed (e.g., connected) in the first position and open (e.g., disconnected) in the second position. Thus, the electrical connection is trippable or disconnectable by moving at least the first arcing contact of the circuit breaker from the first position to the second position. As an option, a movement of both arcing contacts is possible, as well. Furthermore, the circuit breaker includes an arc extinguishing fluid for extinguishing an arc that is formed between the first and the second arcing contact during tripping of the electrical connection, as explained in further detail below. This arc is formed due to the voltages above, for example, 1 kV during or after the arcing contacts are mechanically separated. The arc extinguishing fluid is also used for moving the first arcing contact from the first (e.g., closed) position to the second (e.g., open) position. In other words, the pressurized arc extinguishing fluid acts as an energy reservoir for actuating the movement of the first arcing contact with respect to the second arcing contact. Furthermore, the circuit breaker includes at least one nozzle which is arranged in the arcing chamber. The nozzle is configured to, when the electrical connection is tripped or, in other words, the arcing contacts are separated, direct a flow of the pressurized arc extinguishing fluid towards the arc for extinguishing the arc. In other words, the arc is purged by the arc extinguishing fluid during a natural or artificially induced current zero. Such an artificially induced current zero can be produced, for example, by a commutation or resonant circuit in a DC network via a passive and/or active resonance scheme.

The exemplary circuit breaker also includes a pressure chamber and an expansion chamber. When the circuit breaker is closed or, in other words, when the first arcing contact is in its first position, the arc extinguishing fluid is arranged in the pressure chamber at an overpressure (e.g., at least 7 bar, such as at least 30 bar, or even at least 60 bar) compared to the pressure in the expansion chamber.

In accordance with an exemplary embodiment of the present disclosure, the arc extinguishing fluid is arranged in the pressure chamber at the overpressure compared to the expansion chamber when the first arcing contact is in the first position (e.g., when the electrical circuit is closed), and/or before a separation operation of the arcing contacts is initiated and/or before a tripping command, for example, from a bay controller, is issued to and/or is received by the circuit breaker. Thus, almost all (in terms of Mols) of the arc extinguishing fluid can be kept in the pressure chamber during normal (e.g., non-tripping) operation conditions.

In accordance with an exemplary embodiment of the present disclosure, the pressure chamber and the arcing chamber are not separated by a valve, or, in other words, no valve and/or no fluid conduction means such as tubings is/are arranged between the arcing chamber and the pressure chamber. This has the advantage that the design of the circuit breaker is simplified.

The exemplary circuit breaker also includes at least one movable sealing wall which is mechanically interconnected to the first arcing contact. The sealing wall is structured to transfer a movement of the sealing wall to the first arcing contact. At least a part of the pressure chamber is formed by the sealing wall when the first arcing contact is in its first position. In other words, for tripping the electrical connection, the sealing wall acts as a piston that is moved by the pressurized arc extinguishing fluid and this movement is transferred to the first arcing contact which is brought from its first to its second position. The arc between the first and second arcing contacts is concurrently purged by the flowing arc extinguishing fluid. As a result, the energy which is stored in the pressurized arc extinguishing fluid is used a) for mechanically moving the first arcing contact, and b) for creating a flow in the arc extinguishing fluid which is used to purge the arc.

By using the pressurized arc extinguishing fluid both for contact separation and for arc extinguishing, it is an advantage that the setup of the circuit breaker is simplified and shorter tripping and arc extinguishing times are achieved.

In accordance with an exemplary embodiment of the present disclosure, at least a part of the pressure chamber is formed by the arcing chamber. For example, the pressure chamber and the arcing chamber can be the same chambers. Thus, the setup of the circuit breaker is further simplified, because no separate pressure and arcing chambers are necessary. This helps to decrease complexity of the setup and to further reduce tripping and arc extinguishing times.

In accordance with an exemplary embodiment of the present disclosure, at least one of the arcing contacts—possibly both of the arcing contacts—is/are arranged in the pressure chamber. This has the advantage that the circuit breaker setup is simplified.

In accordance with an exemplary embodiment, the nozzle includes a first section with a linearly or nonlinearly converging inner diameter, and a second section with a linearly or nonlinearly diverging inner diameter. In accordance with an exemplary embodiment, the nozzle also includes at least one third section with a constant inner diameter. The term “inner diameter” relates to a lateral diameter of an inner volume of the nozzle which encloses the arc extinguishing fluid. The sections can be arranged such that between the first and the second section, the inner diameter of the nozzle has a minimum. In accordance with an exemplary embodiment, the third section with the constant diameter shall form the minimum inner diameter of the nozzle and shall thus form the nozzle throat. In other words, a lateral cross section of the nozzle profile can show a convex shape (as shown in the drawings). Then, when the arc is formed near that region with the minimum inner diameter of the nozzle, the flow of the arc extinguishing fluid through the nozzle can more easily be directed towards the arc, and the arc can more effectively be purged by the flow of arc extinguishing fluid through the nozzle.

In accordance with an exemplary embodiment, the first and second arcing contacts are arranged in a coaxial configuration. In other words, axes of the arcing contacts, for example, symmetry axes, are congruent. In accordance with an exemplary embodiment, a contact separation movement direction is also congruent with these symmetry axes. In accordance with an exemplary embodiment, the arcing contacts are arranged in a tulip-plug-configuration or in a head-to-head-configuration. In a tulip-plug-configuration, one arcing contact includes a convex section or protrusion which is configured to be insertable into a concave section or recess of the other arcing contact. In a head-to-head-configuration, convex or flat head sections of the respective arcing contacts are configured to touch each other. Thus, a more reliable electrical connection is achieved when the arcing contacts are closed while a separation of the arcing contacts is not impeded.

In accordance with an exemplary embodiment, the sealing wall can be structured to exhibit different shapes. As examples, the sealing wall can be flat, curved, or calotte-shaped. Thus, an interaction of the pressurized arc extinguishing fluid with the sealing wall that acts as a piston during a tripping of the electrical circuit can be optimized to achieve shorter arcing contact separation times.

In accordance with an exemplary embodiment, the circuit breaker can also include at least one movable baffle that can, for example, act as “assistant piston” in addition to the sealing wall. The baffle is mechanically interconnected to the first arcing contact, and a movement of the baffle is transferred to the first arcing contact similarly as for the sealing wall. In other words, for tripping the electrical connection, the baffle which is additional to the sealing wall can act as a piston that is moved by the pressurized arc extinguishing fluid, and this movement is transferred to the first arcing contact which is brought from its first to its second position. This has the advantage that an interaction of the pressurized arc extinguishing fluid with the baffle and sealing wall during a tripping of the electrical circuit can be optimized to achieve shorter arcing contact separation times. Furthermore, an arc extinguishing fluid flow condition which is suitable for efficient arc extinguishing can more easily be shaped using the additional baffle, as explained in more detail below.

In accordance with an exemplary embodiment, a latch is arranged in the circuit breaker for inhibiting a movement of the first arcing contact from the first position to the second position. In other words, during normal operation (e.g., when the electrical connection is kept closed), the overpressure of the arc extinguishing fluid in the pressure chamber is kept up. Suitable sealing means, such as O-rings, for example, can be arranged, for example, on the sealing wall and/or on nonmoving parts for this purpose. Then, for tripping the electrical connection, the latch is opened and the pressurized arc extinguishing fluid moves the sealing wall and thus mechanically separates the arcing contacts by moving the first arcing contact from its first position to its second position.

In accordance with an exemplary embodiment, the circuit breaker includes a contact closer which moves the first arcing contact from its second position back to its first position. In other words, the contact closer is used, for example, after a tripping of the electrical connection to reclose the arcing contact. Thus, normal operation conditions can be restored. In accordance with an exemplary embodiment, the contact closer includes an energy storage unit which is configured to store at least a part of the kinetic energy of a movement of the first arcing contact from the first position to the second position. Thus, energy is saved.

In accordance with an exemplary embodiment, the circuit breaker is configured to move the first arcing contact from its first position to its second position and to extinguish the arc between the arcing contacts within 20 ms, for example, within 10 ms, such as within 5 ms. Thus, swifter reaction times are achieved and damage to electrical equipment, for example, in a failure situation, is more reliably avoided or reduced.

Exemplary embodiments of the present disclosure also provide for the use of a circuit breaker as described above for tripping an electrical connection in a medium or high voltage power transmission or distribution network, for example, in a medium or high voltage DC power transmission or distribution network.

In such a DC network, upon occurrence of a fault, the circuit breaker (e.g., circuit breaker with DC interruption capability) is tripped, an artificially induced current zero is induced, for example, by using a commutation circuit or a resonant circuit for, in particular over, the circuit breaker, and subsequently the current is interrupted at this current zero. Thus, the circuit breaker can, for example, achieve DC interruption capability by its very fast interruption times (e.g., achieved according to the present disclosure) and/or by a commutation or resonant circuit being arranged in the network (e.g., being arranged in parallel and/or in series to the circuit breaker).

Exemplary embodiments of the present disclosure also provide a method for interrupting (e.g. tripping) or establishing (e.g., closing) an electrical connection in a medium or high voltage power transmission or distribution network by means of a circuit breaker as described above. Thus, in a fault situation, for example, the electrical connection can more swiftly be tripped and damage in the power transmission or distribution can be avoided or reduced.

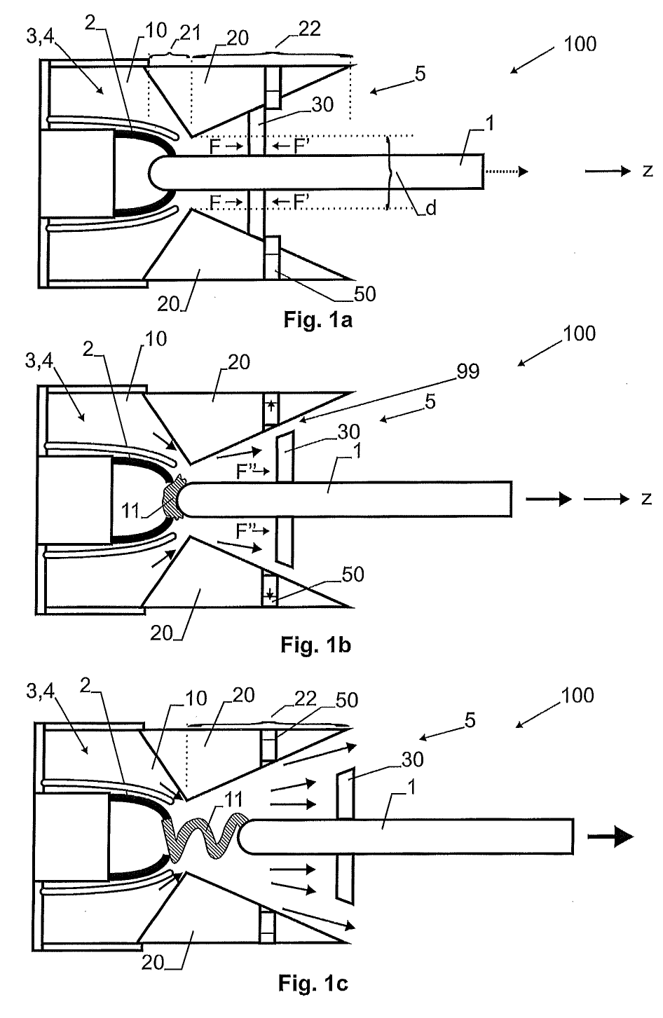

FIG. 1a shows a cross section through an exemplary embodiment of a circuit breaker 100 in a closed position. The circuit breaker 100 includes a first arcing contact 1 and a second arcing contact 2 which are arranged coaxially (about symmetry axis z) in a tulipplug configuration. The first arcing contact 1 is in a first position, for example, is electrically connected to the second arcing contact 2. An arc extinguishing fluid (e.g., technical air) 10 is arranged at an overpressure of 60 bar (compared to an absolute pressure of a few bar, e.g., below 10 bar in an expansion chamber 5) inside a pressure chamber 4 (with its volume being, for example, 3 liters) which is congruent with an arcing chamber 3 of the circuit breaker 100. The term “arcing chamber” relates to the volume of the circuit breaker where an electrical arc is formed between the first and the second arcing contacts 1, 2 during a separation of the arcing contacts 1, 2. The arcing or pressure chamber 3, 4 is delimited on one side by a sealing wall 30 which provides a fluid-tight seal. The sealing wall 30 is mechanically fixed to the first arcing contact 1, which is structured to be movable along the +z direction. Due to the overpressure of the arc extinguishing fluid 10 in the pressure chamber 4 compared to the expansion chamber 5, an initial force F with direction +z is exerted onto the sealing wall 30 and the first arcing contact 1. This initial force F is given by F=p·A, with A being the area of the sealing wall 30 which is in contact with the arc extinguishing fluid 10, and p being the overpressure of the arc extinguishing fluid 10. Initial pushing forces on the order of O(10¹) kN may be obtained. The initial pushing force F is counteracted by a holding force F′ along −z from a latch 50, which holds the sealing wall 30 in position, thus seals the pressure chamber 4, and keeps up the overpressure of the arc extinguishing fluid 10 in the pressure chamber 4.

For clarity, the initial pushing force F is counteracted by a holding force F′ along −z from a latch 50, before a separation operation of the arcing contacts 1, 2 is initiated and/or before a tripping command is received by the circuit breaker 100, wherein the latch 50 holds the sealing wall 30 in position, thus seals the pressure chamber 4, and keeps up the overpressure of the arc extinguishing fluid 10 in the pressure chamber 4.

Furthermore, the circuit breaker 100 includes a nozzle 20 with a first section 21 and a second section 22. In the first section 21, the nozzle 20 exhibits a linearly converging inner diameter d along +z (e.g., the nozzle's lateral opening diameter decreases along +z) whereas in the second section 22, the nozzle 20 exhibits a linearly diverging inner diameter d. In other words, the inner diameter d of the nozzle 20 has a minimum (so-called “nozzle throat”) between the first section 21 and the second section 22. A contact position of the first and second arcing contacts 1, 2 is arranged near the nozzle throat.

For clarity, the axial contact position (e.g., axial position of contacting or touching) of the first and second arcing contacts 1, 2 can be arranged near the axial position of the nozzle throat, for example, can be in vicinity to the center of the nozzle throat, and/or can have an axial distance to the center of the nozzle throat of less than five times of the diameter of the nozzle throat.

FIG. 1b shows a cross section through the exemplary embodiment of the circuit breaker from FIG. 1a in a partly opened position. Here, a tripping command has been issued to the circuit breaker, which leads to an opening or releasing of the latch 50, e.g. by an electromagnetic coil in the latch 50. Then, the initial force F (see above) pushes the sealing wall 30 and the first arcing contact 1 along the +z direction. In other words, the sealing wall 30 acts as a piston in this case. The relatively high initial force F leads to high accelerations of the moving parts, for example, of the sealing wall 30 and the first arcing contact 1. Exemplary movable masses are in the range of few kg, and may be below 10 kg. In this exemplary embodiment, exemplary initial accelerations are in the range of several km/s², for example, larger than 1 km/s². Due to the movement of the sealing wall 30 along the +z direction, the arcing contacts 1, 2 are mechanically separated and an arc 11 starts to build up between the first and second arcing contact 1 and 2. During the movement along +z, an annular exhaust gap 99 is created between the diverging section 22 of the nozzle 20 and the sealing wall 30, that leads to fluid flow (black arrows) and drop of overpressure in the pressure chamber 4. In this phase (which can be called first phase), the design of the nozzle 20 and the sealing wall 30 ensures that this gap is the “throat” of the pressure chamber 4 for several centimeters (e.g., 10 cm) of travel along +z of the sealing wall 30 and the first arcing contact 1. The term “throat” relates to the smallest opening of the pressure chamber 4 in a down-pressure direction. In other words, this means that upstream of the throat there is a subsonic (and thus still high pressure) arc extinguishing fluid flow regime that continues to apply a large force F>F″ and pushes the sealing wall 30 and the first arcing contact 1 further along the +z direction. In this phase, contact separation occurs and the arc 11 is “drawn” between the first arcing contact 1 and the second arcing contact 2; then the arc 11 burns in the high pressure subsonic flow regime of the arc extinguishing fluid 10.

FIG. 1c shows a cross section through the exemplary embodiment of the circuit breaker 100 from FIGS. 1a and 1b in a further opened position. Here, the first arcing contact 1 is almost in a fully opened second position, for example, it is mechanically disconnected from the second arcing contact 2 but still electrically connected through the burning arc 11. In this phase, this arc 11 is about to be purged by the flow of the arc extinguishing fluid 10 during a natural (for AC currents) or artificially induced (for DC currents) current zero through the arc 11. In this phase (which can be called second phase), the annular exhaust area defined by the gap between the sealing wall 30 and the diverging section 22 of the nozzle 20 becomes bigger than the nozzle throat area (e.g., the nozzle throat becomes the throat of the pressure chamber 4). Then, the Mach=1 plane is established at the nozzle throat and thus the necessary flow conditions for arc extinguishing are established at the nozzle throat (e.g., the Mach=1 plane is established in the flow of the arc extinguishing fluid). These flow conditions lead to successful arc interruption in the circuit breaker 100.

To summarize, the circuit breaker 100 is capable of performing a faster contact separation and arc extinguishing because it is actuated by self-stored pressurized arc extinguishing fluid 10. The term “self-stored” relates to the fact that the storage volume for the pressurized arc extinguishing fluid 10 (e.g., the pressure chamber 4) is actually at least in part made up by the arcing chamber 3 itself. Therefore, no tubings or similar fluid conduction means need to be used. In the first position, the pressure chamber 4 is closed by the sealing wall 30, which is fixed to the movable first arcing contact 1. The sealing wall 30 acts as a valve and as a piston, because it opens the outflow of the pressurized arc extinguishing fluid 10 and it concurrently actuates the contact separation. Proper design and dimensioning of the circuit breaker enables the stored pressurized arc extinguishing fluid 10 to perform very fast contact displacement (in a few ms, e.g., below 10 ms) and to perform blowing of the gaseous arc 11 for arc extinction on the same timescale.

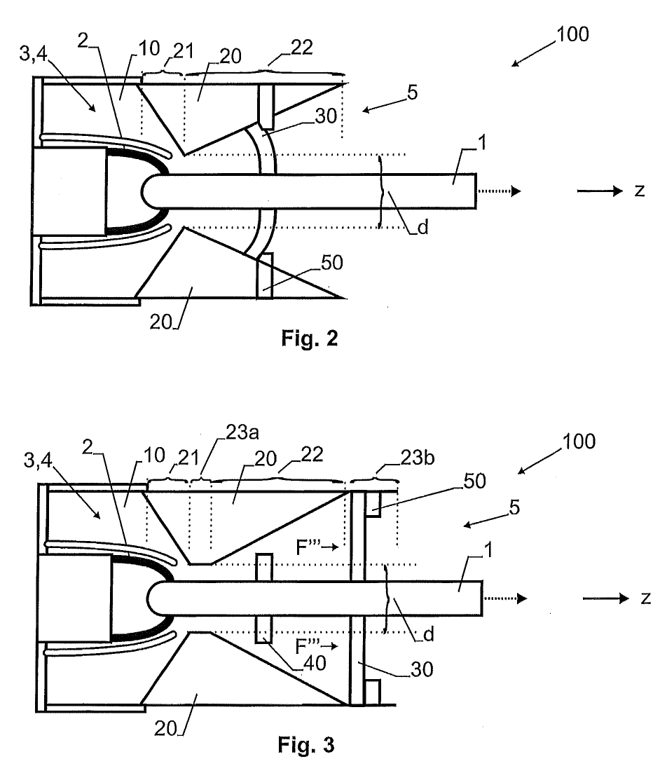

FIG. 2 shows a cross section through an exemplary embodiment of a circuit breaker 100 according to the present disclosure. The exemplary embodiment of FIG. 2 is similar to the exemplary embodiment described above with respect to FIGS. 1a-1c, with the exception of a curved (concave-shaped) sealing wall 30 instead of the flat sealing wall 30 from the exemplary embodiment of FIGS. 1a-1c. This leads to a higher mechanical robustness. Other shapes are possible, as well.

FIG. 3 shows a cross section through an exemplary embodiment of a circuit breaker 100 according to the present disclosure. The exemplary embodiment of FIG. 3 is similar to the exemplary embodiments described above, with the exception that it, in addition to the sealing wall 30, includes a baffle 40 fixed on the first arcing contact 1. Furthermore, the nozzle is shaped differently in that it includes two third sections 23a and 23b with constant inner diameters. At the first position, the sealing wall 30 takes care of the sealing of the pressure chamber 4, while the whole pressure chamber volume including the volumes on both sides of the baffle 40 is/are at overpressure. After a release of the latch 50, the sealing wall 30 is more strongly accelerated due to its larger diameter. After only a few mm of travel along the +z direction, the area between the baffle 40 and the diverging section 22 of the nozzle 20 becomes the throat (after the sealing wall 30 passes an end of the third section 23b of the nozzle 20). This results in a lower pressure regime between the baffle 40 and the sealing wall 30 compared to the arcing chamber 3. In this phase, things are brought back to the scenario described above in the exemplary embodiment of FIG. 1b. Advantages of this design are: first, a sealing of the pressure chamber 4 can be implemented more easily in the contact surface between the third section 23b of the nozzle 20 with constant inner diameter d and the sealing wall 30, and second, the use of the larger sealing wall 40 results in a higher initial acceleration due to an increased initial force F′″>F (as compared to FIG. 1a). This leads to a reduction of contact separation times and arc extinguishing times.

FIG. 4 shows a cross section through an exemplary embodiment of a circuit breaker 100 according to the present disclosure including a two-part pressure chamber 4, which is in part arranged around the arcing chamber 3. The exemplary embodiment of FIG. 4 also includes a damper 60, which is a part of a contact closer 70. Otherwise, the exemplary embodiment of FIG. 4 is similar to the above-described exemplary embodiments. The additional part of the pressure chamber 4, which is arranged around the arcing chamber 3, provides additional initial acceleration to the sealing wall 30. The additional part of the pressure chamber 4 can be separated or connected to the original pressure chamber 4, for example, the inner part of the pressure chamber 4, which is congruent with the arcing chamber 3. Here, the outer part of the pressure chamber 4 is connected to the inner part of the pressure chamber 4 through connection holes 98, as shown in FIG. 4. Due to the larger contact area of the pressurized arc extinguishing fluid 10 with the sealing wall 30, the initial acceleration of the sealing wall or outer plate 30 is increased. This leads to reduced contact separation and arc extinguishing times.

With proper design, the initial “kick” or acceleration can be sufficient for obtaining the desired contact separation and arc extinguishing performances so that the baffle 40 can be optional. For example, nominal contacts can be implemented by using the sealing wall 30 as nominal contact in its closed or first position. In other words, the sealing wall 30 can be part of a nominal contact system of the circuit breaker 100.

At the end of the OPEN operation described above, the deceleration (e.g., damping) and stop of the moving first arcing contact 1, sealing wall 30, and baffle 40 can be achieved by the damper 60. In this exemplary embodiment, the damper 60 includes, for example, a set of springs (e.g., mechanical, pneumatic, etc.) that are compressed and latched after compression. These springs also act as an energy storage unit 71 for the contact closer 70. The secondary latches can be part of the contact closer 70, and they can be released to reclose the nominal and arcing contacts 1, 2 of the circuit breaker 100. The energy required during the CLOSE operation is harnessed from the kinetic energy produced during the OPEN operation as described above. The CLOSE operation has to counteract mainly the plug-tulip contact force (on the order of O(100) N) and the friction force between the nominal contacts. Once the arcing contacts 1, 2 are closed, the latch 50 is energized again and the pressure chamber 4 is then refilled with pressurized arc extinguishing fluid 10 to be ready for the next OPEN operation. An OPEN-CLOSE-OPEN (OCO) operation is also possible, when the pressure chamber 4 is rapidly refilled with arc extinguishing fluid 10 at the necessary overpressure. Because a volume of the order of 1 liter, i.e. O(1) liters, is sufficient, a fast pressure charging of the pressure chamber 4 is achievable, for example, by means of several filling inlets.

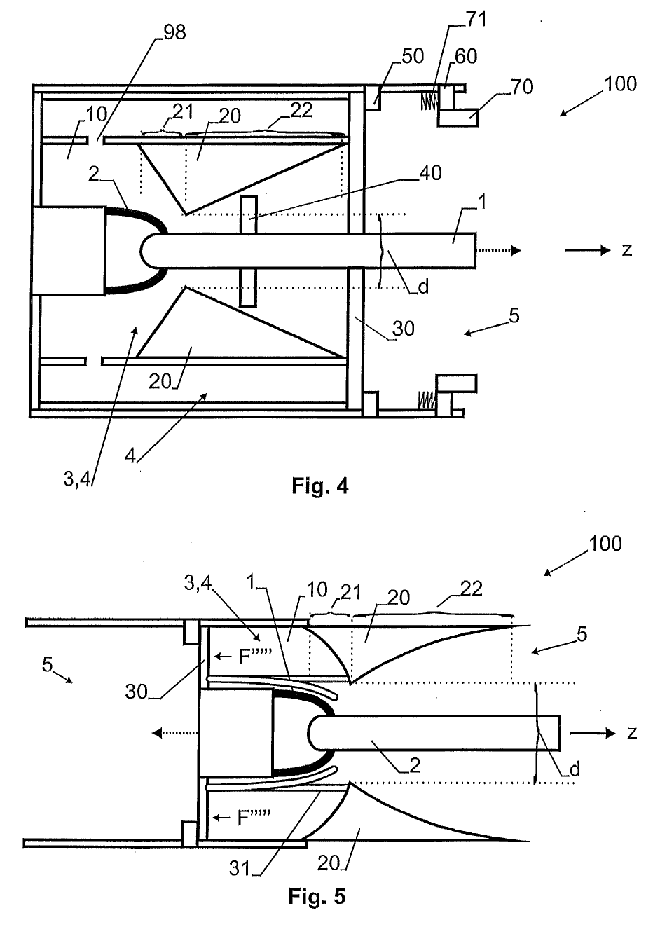

FIG. 5 shows a cross section through an exemplary embodiment of a circuit breaker 100 according to the present disclosure. The exemplary embodiment of FIG. 5 includes a nozzle 20 with sections 21 and 22 with nonlinearly converging and nonlinearly diverging inner diameters d. In other words, the nozzle 20 has a nonlinearly converging first section 21 (e.g., with decreasing diameter when moving through the nozzle 20 from left to right or along a preferred gas blowing direction) and a nonlinearly diverging second section 22 (e.g., with increasing diameter when moving through the nozzle 20 from left to right or along a preferred gas blowing direction). Please note that generally the nozzle sections can also be nonlinearly converging and linearly diverging, or vice versa linearly converging and nonlinearly diverging. Furthermore, the first and second arcing contacts are swapped, for example, the first arcing contact 1 is movable along the −z direction and structured as tulip, while the second (fixed) arcing contact 2 is structured as plug. As shown in FIG. 5, an additional sealing tube 31 is arranged in the arcing or pressure chamber 3, 4 and moves along −z together with the first arcing contact 1 and the sealing wall 30. An advantage of this exemplary embodiment is that a larger actuating area can be used on the sealing wall 30 which results in a higher initial force F′″″>F (as compared to FIG. 1a). Furthermore, flow perturbations in the nozzle are reduced.

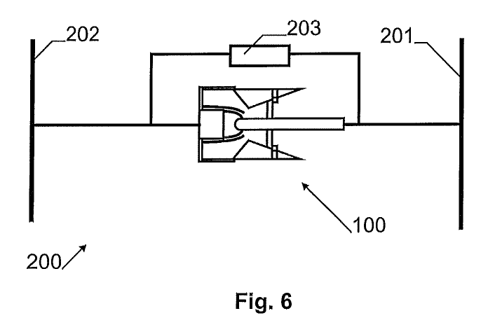

FIG. 6 shows a schematic representation of a DC medium or high-voltage power transmission or distribution network including a circuit breaker 100 according to an exemplary embodiment of the present disclosure. The circuit breaker 100 is used to open and/or to close an electrical connection between a first bus bar 201 and a second bus bar 202. Contact separation and arc extinguishing is achieved within less than 10 ms. A resonant circuit 203 can be arranged in parallel to the circuit breaker 100 for creating an artificially induced current zero via a passive and/or active resonance scheme during which the arc is extinguished.

An exemplary embodiment of the present disclosure provides a method for interrupting or establishing an electrical connection in a medium or high-voltage power transmission or distribution network 200, for example, in a medium or high-voltage DC power transmission and distribution network, by means of a circuit breaker 100 as disclosed herein.

In accordance with an exemplary embodiment, the method for interrupting the electrical connection in the medium or high-voltage DC power transmission network 200 includes steps of receiving a tripping command by the circuit breaker 100, accelerating the sealing wall 30 and the first arcing contact 1 and mechanically separating the arcing contacts 1, 2 by the pressurized arc-extinguishing fluid 10 from the pressure chamber 4, creating and/or changing an exhaust gap 99 between the nozzle 20 and the sealing wall 30 or between the nozzle 20 and a baffle 40 (if present), and purging the arc 11 by a flow of the arc-extinguishing fluid 10 through the nozzle 20.

In accordance with an exemplary embodiment, the exhaust gap 99 forms a throat of the pressure chamber 4 during a first period, and a nozzle throat forms a throat of the pressure chamber 4 during a second period, wherein the arc 11 is purged during the second period.

In accordance with an exemplary embodiment, the method also includes a step of establishing a Mach=1 plane in the flow of the arc-extinguishing fluid 10 at the nozzle 20. In addition, the method may also not include a step of opening a valve between the pressure chamber 4 and the arcing chamber 3.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

Definitions:

The term “fluid” relates to “a substance, such as a liquid and/or gas, that can flow, has no fixed shape, and offers little resistance to an external stress” (from http://www.thefreedictionary.com/fluid, accessed on Sep. 11, 2011).

The term “medium voltage” relates to AC or DC voltages larger than or equal to 1 kV.

The term “high voltage” relates to AC or DC voltages larger than or equal to 72 kV.

The term “arcing chamber” relates throughout the present disclosure to the volume of the circuit breaker where an electrical arc is formed between the first and the second arcing contacts 1, 2 during a separation of the arcing contacts 1, 2.

The term “throat” relates throughout the present disclosure to the smallest opening of the pressure chamber 4 in a down pressure direction. Down pressure direction means the direction of diminishing pressure.

The term “tripping” shall be understood broadly to also encompass actuating or starting moving or moving the electrical contacts.

Notes:

Exemplary tripping currents are on the order of 10 kA, e.g., O(10¹) kA, or more.

### REFERENCE NUMBERS

1, 2 arcing contacts
3 arcing chamber
4 pressure chamber
5 expansion chamber
10 arc extinguishing fluid
11 arc
20 nozzle
21, 22 first and second sections of nozzle 20
23a, 23b third sections of nozzle 20
d inner diameter of nozzle 20
30 sealing wall, outer plate
31 sealing tube
40 baffle
50 latch
60 damper
70 contact closer
71 energy storage unit of contact closer 70
98 connection holes
99 exhaust gap, annular exhaust gap
100 circuit breaker
200 power transmission or distribution network
201, 202 bus bars
203 commutation circuit, resonant circuit.

What is claimed is:

1. A medium or high-voltage circuit breaker comprising
at least one first arcing contact and at least one second arcing contact arranged in an arcing chamber, the first arcing contact being movable with respect to the second arcing contact from a first position to a second position, an electrical connection between the arcing contacts being closed in the first position and open in the second position;
an arc extinguishing fluid configured to extinguish an arc between the first arcing contact and the second arcing contact, and to move the first arcing contact from the first position to the second position;
at least one nozzle arranged in the arcing chamber and configured to direct a flow of the arc extinguishing fluid towards the arc for extinguishing the arc;
a pressure chamber and an expansion chamber, the arc extinguishing fluid being arranged in the pressure chamber at an overpressure to the expansion chamber when the first arcing contact is in the first position;
at least one movable sealing wall mechanically interconnected to the first arcing contact, the mechanical interconnection being configured to transfer a movement of the sealing wall to the first arcing contact,
wherein at least a part of the pressure chamber is formed by the sealing wall when the first arcing contact is in the first position.

2. The circuit breaker of claim 1, wherein a part of the pressure chamber is formed by the arcing chamber.

3. The circuit breaker of claim 2, wherein the pressure chamber and the arcing chamber are the same chamber.

4. The circuit breaker of claim 1, wherein a part of the pressure chamber is arranged around the arcing chamber.

5. The circuit breaker of claim 1, wherein the arcing contacts are arranged in the pressure chamber.

6. The circuit breaker of claim 1, wherein the nozzle comprises:
a first section with a linearly or nonlinearly converging inner diameter; and
a second section with a linearly or nonlinearly diverging inner diameter.

7. The circuit breaker of claim 6, wherein the nozzle comprises:
at least one third section with a constant inner diameter.

8. The circuit breaker of claim 1, wherein the nozzle includes a nozzle throat, and a contact position of the first and second arcing contacts is arranged near the nozzle throat.

9. The circuit breaker of claim 1, wherein the overpressure of the arc extinguishing fluid in the pressure chamber is at least 7 bar.

10. The circuit breaker of claim 1, wherein the arcing contacts are arranged in a coaxial configuration.

11. The circuit breaker of claim 1, wherein the sealing wall is one of flat, curved and calotte-shaped.

12. The circuit breaker of claim 1, comprising:
at least one movable baffle mechanically interconnected to the first arcing contact,
wherein the mechanical interconnection is configured to transfer a movement of the baffle to the first arcing contact.

13. The circuit breaker of claim 1, comprising:
a latch configured to inhibit a movement of the first arcing contact from the first position to the second position and to up-keep the overpressure of the arc extinguishing fluid in the pressure chamber.

14. The circuit breaker of claim 1, comprising:
a damper configured to decelerate and stop a movement of the first acting contact and the sealing wall.

15. The circuit breaker of claim 1, wherein the circuit breaker is configured to move the first arcing contact from the first position to the second position and to extinguish the arc between the first arcing contact and the second arcing contact within 20 ms.

16. The circuit breaker of claim 1, wherein the circuit breaker is not equipped with any tubings or fluid conduction means for the arc-extinguishing fluid.

17. The circuit breaker of claim 1, wherein the arc-extinguishing fluid is arranged in the pressure chamber at an overpressure to the expansion chamber at least one of:
before a separation operation of the arcing contacts is initiated, and
before a tripping command is received by the circuit breaker.

18. A power transmission or distribution network comprising:
at least one circuit breaker of claim 1; and
one of a commutation circuit and a resonant circuit configured to create an artificially induced current zero for the at least one circuit breaker.

19. A method for interrupting or establishing an electrical connection in a medium or high-voltage power transmission or distribution network, by means of a medium or high-voltage circuit breaker,
wherein the circuit breaker includes:
at least one first arcing contact and at least one second arcing contact arranged in an arcing chamber, the first arcing contact being movable with respect to the second arcing contact from a first position to a second position, an electrical connection between the arcing contacts being closed in the first position and open in the second position;
an arc extinguishing fluid configured to extinguish an arc between the first arcing contact and the second arcing contact, and to move the first arcing contact from the first position to the second position;
at least one nozzle arranged in the arcing chamber and configured to direct a flow of the arc extinguishing fluid towards the arc for extinguishing the arc;
a pressure chamber and an expansion chamber, the arc extinguishing fluid being arranged in the pressure chamber at an overpressure to the expansion chamber when the first arcing contact is in the first position;
at least one movable sealing wall mechanically interconnected to the first arcing contact, the mechanical interconnection being configured to transfer a movement of the sealing wall to the first arcing contact,
wherein at least a part of the pressure chamber is formed by the sealing wall when the first arcing contact is in the first position, and
wherein the method comprises:
receiving a tripping command by the circuit breaker;
accelerating the sealing wall and the first arcing contact and mechanically separating the arcing contacts by the pressurized arc-extinguishing fluid from the pressure chamber;
at least one of creating and changing an exhaust gap between the nozzle and the sealing wall or between the nozzle and a baffle; and
purging the arc by a flow of the arc-extinguishing fluid through the nozzle.

20. The method of claim 19, wherein:
the exhaust gap forms a throat of the pressure chamber during a first period;
a nozzle throat of the nozzle forms a throat of the pressure chamber during a second period; and
the arc is purged during the second period.

21. The method of claim 19, comprising:
establishing a Mach=1 plane in the flow of the arc-extinguishing fluid at the nozzle.

22. The method of claim 20, comprising:
establishing a Mach=1 plane in the flow of the arc-extinguishing fluid at the nozzle; and
not opening a valve between the pressure chamber and the arcing chamber.

23. The circuit breaker of claim 2, wherein a part of the pressure chamber is arranged around the arcing chamber.

24. The circuit breaker of claim 23, wherein the arcing contacts are arranged in the pressure chamber.

25. The circuit breaker of claim 8, wherein the contact position of the first and second arcing contacts is arranged within an axial distance to a center of the nozzle throat of less than five times a diameter of the nozzle throat

26. The circuit breaker of claim 6, wherein the nozzle includes a nozzle throat, and an axial contact position of the first and second arcing contacts is arranged near the nozzle throat, within an axial distance to a center of the nozzle throat of less than five times a diameter of the nozzle throat.

27. The circuit breaker of claim 9, wherein the overpressure of the arc extinguishing fluid in the pressure chamber is at least 30 bar.

28. The circuit breaker of claim 9, wherein the overpressure of the arc extinguishing fluid in the pressure chamber is at least 60 bar.

29. The circuit breaker of claim 10, wherein the arcing contacts are arranged in one of a tulip-plug-configuration and a head-to-head-configuration.

30. The circuit breaker of claim 11, wherein the sealing wall is part of a nominal contact system of the circuit breaker.

31. The circuit breaker of claim 1, wherein the sealing wall is part of a nominal contact system of the circuit breaker.

32. The circuit breaker of claim 14, comprising:
at least one movable baffle mechanically interconnected to the first arcing contact,
wherein the mechanical interconnection is configured to transfer a movement of the baffle to the first arcing contact, and
wherein the damper is configured to decelerate and stop the movement of the first acting contact, the sealing wall and the baffle.

33. The circuit breaker of claim 14, comprising:
a contact closer configured to move the first arcing contact from the second position to the first position,
wherein the contact closer comprises an energy storage unit configured to store at least a part of the kinetic energy of a movement of the first arcing contact from the first position to the second position.

34. The circuit breaker of claim 1, comprising:
a contact closer configured to move the first arcing contact from the second position to the first position,
wherein the contact closer comprises an energy storage unit configured to store at least a part of the kinetic energy of a movement of the first arcing contact from the first position to the second position.

35. The circuit breaker of claim 15, wherein the circuit breaker is configured to move the first arcing contact from the first position to the second position and to extinguish the arc between the first arcing contact and the second arcing contact within 10 ms.

36. The circuit breaker of claim 15, wherein the circuit breaker is configured to move the first arcing contact from the first position to the second position and to extinguish the arc between the first arcing contact and the second arcing contact within 5 ms.

37. The circuit breaker of claim 15, comprising:
one of a commutation circuit and a resonant circuit configured to artificially induce a current zero.

38. The circuit breaker of claim 1, comprising:
one of a commutation circuit and a resonant circuit configured to artificially induce a current zero.

39. The circuit breaker of claim 16, wherein the circuit breaker is not equipped with a valve for the arc extinguishing fluid between the pressure chamber and the arcing chamber.

40. The circuit breaker of claim 1, wherein the circuit breaker is not equipped with a valve for the arc extinguishing fluid between the pressure chamber and the arcing chamber.

41. The power transmission or distribution network of claim 18, wherein the power transmission or distribution network is a medium or high-voltage DC power transmission or distribution network.

42. The method of claim 19, comprising:
opening a valve between the pressure chamber and the arcing chamber.

43. The circuit breaker of claim 6, wherein the sealing wall is part of a nominal contact system of the circuit breaker.

44. The circuit breaker of claim 11, comprising:
at least one movable baffle mechanically interconnected to the first arcing contact,
wherein the mechanical interconnection is configured to transfer a movement of the baffle to the first arcing contact.
